(19) United States
(12) Patent Application Publication
(10) Pub. No.: US 2020/0197846 A1
(43) Pub. Date: Jun. 25, 2020

(54) FILTER CARTRIDGE CONNECTING STRUCTURE FOR WATER PURIFIER

(71) Applicant: Ho Sung Yoon, Hwaseong-si (KR)

(72) Inventor: Ho Sung Yoon, Hwaseong-si (KR)

(21) Appl. No.: 16/230,794

(22) Filed: Dec. 21, 2018

(51) Int. Cl. B01D 35/30; C02F 1/44

(52) U.S. Cl. CPC B01D 35/30; C02F 1/441; B01D 2201/30; C02F 2201/006; B01D 2201/16; B01D 2201/0461; B01D 2201/29

(57) ABSTRACT

Disclosed is a filter cartridge connecting structure for a water purifier, including: a plurality of connectors; and a plurality of filter cartridges each having a mounting part and a groove formed on the mounting part, wherein each connector includes: an upper body having a water inlet port, a water inlet pipe, a filter cartridge insertion pipe, a water outlet port, and a finishing cap; a lower body having a tunnel-shaped guide part, an operating hole, operating grooves, and slant projections; and a detachable member having a front surface guided to the guide part of the lower body and one side movable forward and backward on the operating hole in such a manner as to supportedly lock the groove of the mounting part of the filter cartridge guided under the lower body thereonto.

### BACKGROUND OF THE INVENTION

### Field of the Invention

The present invention relates to a filter cartridge connecting structure for a water purifier, and more particularly, to a filter cartridge connecting structure for a water purifier that is configured to have detachable members simply coupled to connectors disposed in the water purifier in such a manner as to allow a plurality of filter cartridges to be detachably attached to the connectors in a simple and stable manner by means of one touch, so that as the detachable members are just pressed, without having any separate spring members, the filter cartridges can be detached from the connectors and then exchanged with new ones.

### Background of the Related Art

Generally, a water purification line is connected to a tap water supply pipe in a household or office to purify the supplied water once again, so that the purified water is used as drinking water.

In case of tap water fed after a drinking water treatment, typically, chlorine used for disinfection is not easily removed out of the tap water, so that it remains in the water, thereby causing chlorine smell from the tap water.

If an amount of chlorine remaining in the tap water is large, dermatitis and atopic diseases may occur to children or people having sensitive skin, and even if the tap water is boiled, the evaporated chlorine is emitted to the air to give bad influences to people having weak bronchi and lungs and further to generate carcinogens like trihalomethane.

So as to remove the chlorine from the tap water, accordingly, a plurality of exchangeable filters are mounted onto a water purifier used for drinking water to filter the tap water therethrough, and such filters for water purification are made of various materials capable of improving water purification effects.

In the water purification of the raw water fed to the water purifier through the plurality of filters, the purified drinking water is obtained through three to five filtering steps according to water purification performance, and the filters include a sediment filter, a carbon filter, a reverse osmosis filter or hollow fiber filter, and a post carbon filter.

The sediment filter, which is well known as a pre treatment filter, is made of polypropylene to remove suspended solids like dust, sand, and rusty water in a pipe from the raw water and to initially remove particles greater than 0.1 μm, thereby functioning as an important filter for extending a life span of the carbon filter disposed adjacent thereto.

The carbon filter disposed just adjacent to the sediment filter is a pre carbon filter adapted to filter heavy metals and general bacteria having particles greater than 0.1 μm and is made of activated charcoal so that a product having particle type activated charcoal put in a housing or a product having the activated charcoal compressedly molded to a given shape is used as the carbon filter.

After the carbon filter, the reverse osmosis filter and the hollow fiber filter are selectively disposed according to the purpose of the purified water to remove fine components dissolved in the water.

According to kinds of membranes, the hollow fiber membrane and the reverse osmosis membrane are selectively used.

The hollow fiber membrane is made of a hollow fiber material having pore sizes of 0.1 to 0.01 μm to remove pollutants contained in the raw water through the numerous fine pores distributed on the surface thereof, to filter impurities, bacteria, chlorine, and so on, and thus to provide weakly alkaline water. In case of the hollow fiber membrane, the water purification time is fast, and the price of the membrane is low, so that the hollow fiber membrane is used for a water purifier in a restaurant where a large amount of water is consumed.

The reverse osmosis membrane is made of a microfilm having pore sizes of 0.0001 μm, and unlike the hollow fiber membrane, performs water purification in the ratio of 7 (waste water):3 (purified water). In this case, the reverse osmosis membrane removes impurities, environmental hormone, heavy metals, and bacteria from the raw water, and accordingly, it is used adequately in purifying groundwater containing lime. The purification speed of the reverse osmosis membrane is slower than that of the hollow fiber membrane, as appreciated from the difference in the pore sizes therebetween.

The post carbon filter, which is called ‘post treatment carbon filter’, serves to perform the water purification at a final position in the purification line and has the longest period of exchange time among the plurality of filters. Like the pre carbon filter, the post carbon filter is made of activated charcoal giving no harm to the human body, and since it is determined whether a quality of water is good or bad by means of the post carbon filter, the post carbon filter functions as a very important filter.

The pre carbon filter and the post carbon filter remove chemicals and smell out of the water and serve to improve the taste of water. The membrane filter serves to filter the fine particles and is replaced with the hollow fiber filter. If the life spans of the filters are finished, the filters have to be exchanged periodically with new ones.

So as to provide easiness in exchanging the filters, the filters are made in the form of exchange type filter cartridges, and such filter cartridges are simply detachably mounted onto connectors disposed in the water purifier, so that they can be exchanged with new ones according to water purification time.

On the other hand, the filter cartridges are mounted in the water purifier by means of a fitting way. In detail, they are connected to a plurality of tubes forming paths for step by step filtering the raw water and a plurality of tube couplings. That is, the tube couplings are fittedly coupled to nipples of the filter cartridges. Otherwise, the filter cartridges are mounted in the water purifier by means of an interlocking or screw fastening way. In detail, circular coupling protrusions are coupled engagingly to coupling protrusions formed on the filter cartridges by means of screw fastening. Accordingly, the filter cartridges can be mounted in the water purifier by means of the fitting and interlocking ways.

In case of the fitting way, the tube couplings are coupled to the nipples of the filter cartridges by means of a plurality of snap hooks, and accordingly, the tube couplings may be easily deformed and damaged, thereby causing liquid leakage.

If plastic deformation occurs on the snap hooks, further, the tubes may be deviated easily from the tube couplings, thereby causing serious failure like liquid leakage.

As a result, recently, the filter cartridges are mounted using the interlocking way rather than the fitting way.

One of conventional technologies related to the filter cartridges mounted onto the connectors is disclosed in Korean Patent Application Laid-open No. 10-2008-0079937 (hereinafter, referred to as ‘Patent document 1’) entitled “water purifier filter assembly having rotary connector”.

According to Patent document 1, the filter assembly improves conveniences in the exchange of the filter cartridges through connectors and includes the connectors and first and second connection members coupled to both sides of each connector and serving as hinge shafts. In this case, the first connection member has a path into which raw water is introduced, and the second connection member has a path from which drinking water filtered through the filter cartridges is discharged.

In case of Patent document 1, accordingly, the filter assembly is configured to allow the first and second connection members to be connected with each other by means of a plurality of tubes and a plurality of tube couplings so as to form the paths between the adjacent connectors, thereby undesirably causing liquid leakage and failure on the tube couplings.

So as to exchange or mount the filter cartridges, further, the rotary connectors have to rotate with respect to the first and second connection members, together with the filter cartridges, so that liquid leakage may occur on coupled portions between the first and second connection members and the rotary connectors.

In addition to the first and second connection members, a raw water blocking member and a path blocking member have to be located at the interior of each rotary connector, which makes an internal design undesirably complicated, and if the filter cartridges are mounted by means of the interlocking way, they are detachably mounted, while being rotated, which causes inconveniences in use.

On the other hand, another conventional technology is disclosed in Korean Patent No. 10-0505861 (hereinafter, referred to as ‘Patent document 2’) entitled “connecting structure capable of easily exchanging filter cartridge for water purifier” and issued on Aug. 4, 2005.

According to Patent document 2, also, connectors are rotatably disposed in the water purifier, and the filter cartridges are inserted into opening and closing valves mounted on the connectors. Further, separate support members are disposed on the undersides of the filter cartridges, and the support members have springs mounted therein to elastically support the undersides of the filter cartridges.

The above-mentioned conventional connecting structure is simple in mounting the filter cartridges onto the connectors, but after the connectors are rotated to mount the filter cartridges thereonto, the filter cartridges rotate toward a body of the water purifier, together with the connectors, in such a manner as to allow their undersides to be guidedly fixed to the support members. If the elasticity of the springs becomes low, however, water leakage may occur according to degrees of pressurizing the filter cartridges.

In case of Patent document 2, the adoption of the support members having the springs occupies the installation space of the filter cartridges, and because of the rotary type connectors, further, the water leakage may occur in the same manner as Patent document 1.

### SUMMARY OF THE INVENTION

Accordingly, the present invention has been made in view of the above-mentioned problems occurring in the prior art, and it is an object of the present invention to provide a filter cartridge connecting structure for a water purifier that is configured to have detachable members simply coupled to connectors disposed in the water purifier in such a manner as to allow a plurality of filter cartridges to be detachably attached to the connectors in a simple and stable manner by means of one touch, so that as the detachable members are just pressed, without having any separate spring members, the filter cartridges can be detached from the connectors and then exchanged, thereby obtaining conveniences in use and economical advantages.

To accomplish the above-mentioned object, according to the present invention, there is provided a filter cartridge connecting structure for a water purifier, including: a plurality of connectors connected in series to one another by means of connection sockets; and a plurality of filter cartridges detachably mounted onto the connectors and thus exchanged with new ones, each filter cartridge having a mounting part and a groove formed on the mounting part, wherein each connector includes: an upper body having a water inlet port for introducing water into the corresponding filter cartridge, a water inlet pipe for inducing the water passing through the water inlet port to the interior of the filter cartridge, a filter cartridge insertion pipe inserted into the filter cartridge, a water outlet port for discharging the water passing through the filter cartridge insertion pipe, and a finishing cap coupled coveredly to top thereof; a lower body having a cylindrical body whose top periphery is attachedly coupled to the underside periphery of the upper body in such a manner as to accommodate the water inlet pipe of the upper body therein and to pass the filter cartridge insertion pipe therethrough, the lower body including a tunnel-shaped guide part protruding from one side thereof, an operating hole formed transversely on the lower portion of the inner side of the guide part, operating grooves formed on both sides of the operating hole, and slant projections formed above the operating hole in such a manner as to be protrudingly connected to the upper portion of the inner side of the guide part; and a detachable member having a front surface guided to the guide part of the lower body and one side movable forward and backward on the operating hole in such a manner as to supportedly lock the groove of the mounting part of the filter cartridge guided under the lower body thereonto.

According to the present invention, desirably, the detachable member includes: a pressing part guided to the guide part; a slide part extended perpendicularly from the underside of the pressing part and having cut portions guided to the operating hole, a first inner diameter portion formed extendedly from the cut portions to guide the outer periphery of the mounting part of the filter cartridge, a second inner diameter portion for lockedly supporting the groove of the mounting part of the filter cartridge, and escape prevention projections formed on both side surfaces thereof in such a manner as to be guided to the operating grooves, while being prevented from the escape from the operating grooves; and an elastic piece protruding vertically from the top of the slide part in such a manner as to allow one side thereof to come into contact with the slant projections of the lower body upon the forward movement of the detachable member to provide elasticity in forward and backward directions of the detachable member.

According to the present invention, desirably, a thickness of the elastic piece becomes small toward the upper portion thereof.

According to the present invention, desirably, the water inlet pipe is configured to allow a check valve and a spring to be guidedly disposed therein.

So as to allow the filter cartridge to be detachably mounted onto the connector by means of one touch in a simple and stable manner, the filter cartridge connecting structure for the water purifier according to the present invention is provided with the upper body, the lower body, and the detachable member pressurized to the form of a forward and backward button from the lower body in such a manner as to be lockedly support the groove of the filter cartridge thereagainst, so that as the detachable member is pressed, the elastic piece disposed on the detachable member is pressurized, without any separate spring, to allow the detachable member to be detachably mounted on the groove of the filter cartridge through the position movements of the first inner diameter portion and the second inner diameter portion, thereby remarkably reducing the manufacturing cost of the connector, and unlike the existing conventional practice further, there is no need to rotate the connector so as to mount the filter cartridge thereon, thereby preventing water leakage occurring on a connection socket point and making a user's handling and using manner simple.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a state where a filter cartridge is mounted on a connector in a filter cartridge connecting structure for a water purifier according to the present invention;

FIG. 2 is a perspective view showing a process where the filter cartridge is mounted on the connector in the filter cartridge connecting structure according to the present invention;

FIG. 3 is a sectional view showing an upper body of the connector in the filter cartridge connecting structure according to the present invention;

FIG. 4 is a perspective view showing a lower body of the connector in the filter cartridge connecting structure according to the present invention;

FIG. 5 is a perspective view showing a detachable member coupled to the lower body of the connector in the filter cartridge connecting structure according to the present invention;

FIG. 6 is a sectional view showing the state where the filter cartridge is mounted on the connector in the filter cartridge connecting structure according to the present invention;

FIG. 7 is a cross sectional view showing a state where the detachable member is coupled to the lower body of the connector in the filter cartridge connecting structure according to the present invention;

FIG. 8 is a sectional view showing a process wherein the filter cartridge is mounted on the connector in the filter cartridge connecting structure according to the present invention;

FIG. 9 is a cross sectional view showing a state where a groove of the filter cartridge is supported against the detachable member in FIG. 8; and

FIG. 10 is a sectional view showing a state where various filter cartridges are mounted on the connectors in the filter cartridge connecting structure according to the present invention.

### DETAILED DESCRIPTION OF THE PREFERRED EMBODIMENTS

Hereinafter, the present invention is in detail disclosed with reference to the attached drawings.

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

Before the present invention is disclosed and described, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure.

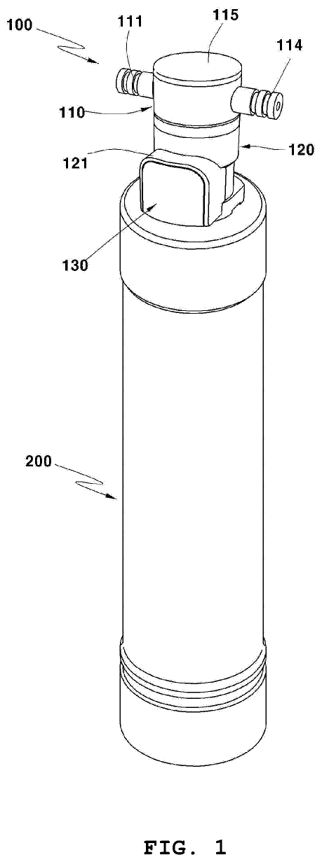

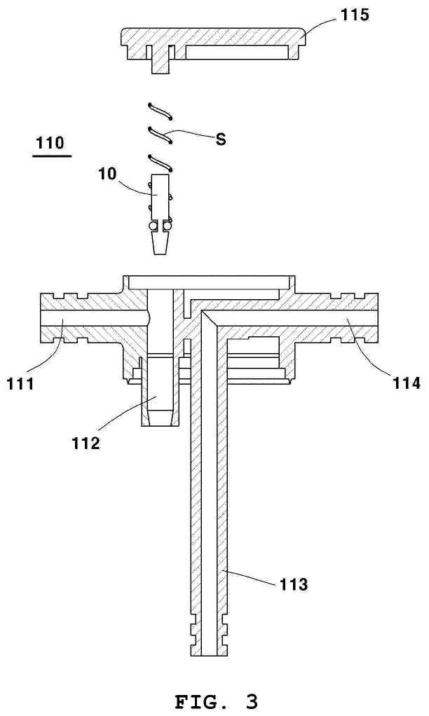

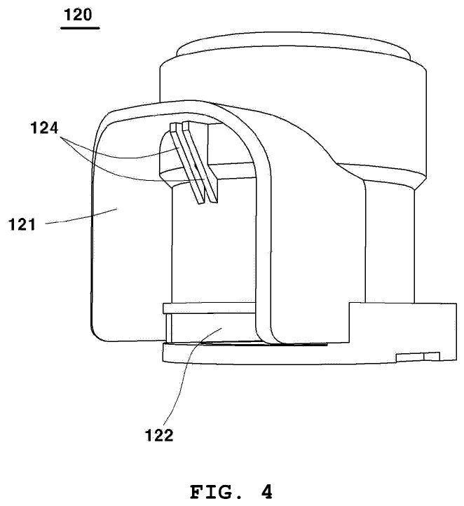

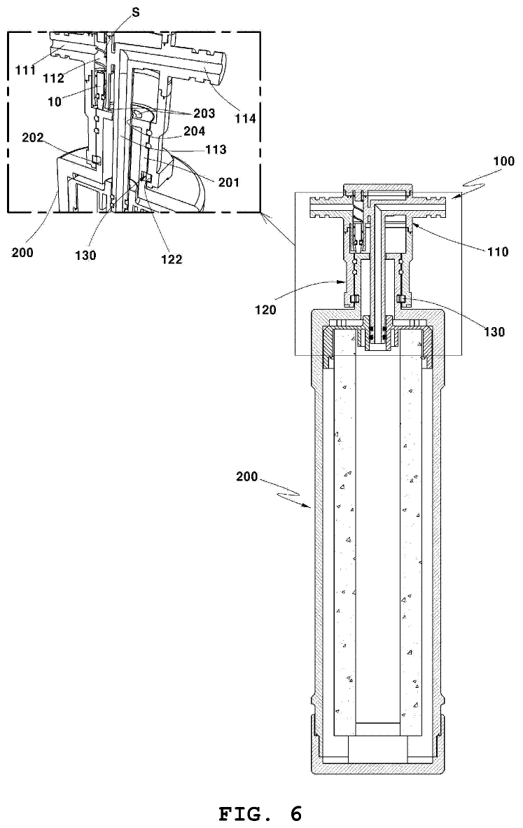

The present invention will be described with reference to FIGS. 1 to 10.

A filter cartridge connecting structure for a water purifier according to the present invention is configured to allow grooves 202 of mounting parts 201 of a plurality of filter cartridges 200 to be supported against a plurality of connectors 100 connected in series to one another by means of connection sockets 1, so that the filter cartridges 200 are detachably mounted onto the connectors 100 and thus exchanged with new ones.

Each connector 100 includes an upper body 110, a lower body 120, and a detachable member 130 and is adapted to detachably mount the corresponding filter cartridge 200 thereonto.

The upper body 110 includes a water inlet port 111 for introducing water into the filter cartridge 200, a water inlet pipe 112 for inducing the water passing through the water inlet port 111 to the interior of the filter cartridge 200, a check valve 10 and a spring S guidedly disposed in the water inlet pipe 112, a filter cartridge insertion pipe 113 inserted into the filter cartridge 200, a water outlet port 114 for discharging the water passing through the filter cartridge insertion pipe 113, and a finishing cap 115 coupled coveredly to top thereof after the check valve 10 is disposed in the water inlet pipe 112.

The lower body 120 has a cylindrical body whose top periphery is attachedly coupled to the underside periphery of the upper body 110 in such a manner as to accommodate the water inlet pipe 112 of the upper body 110 therein and to pass the filter cartridge insertion pipe 113 therethrough and includes a tunnel-shaped guide part 121 protruding from one side thereof, an operating hole 122 formed transversely on the lower portion of the inner side of the guide part 121, operating grooves 123 formed on both sides of the operating hole 122, and slant projections 124 formed above the operating hole 122 in such a manner as to be protrudingly connected to the upper portion of the inner side of the guide part 121.

The detachable member 130 includes a front surface guided to the guide part 121 of the lower body 120 and one side movable forward and backward on the operating hole 122 in such a manner as to supportedly lock the groove 202 of the mounting part 201 of the filter cartridge 200 guided under the lower body 120 thereonto.

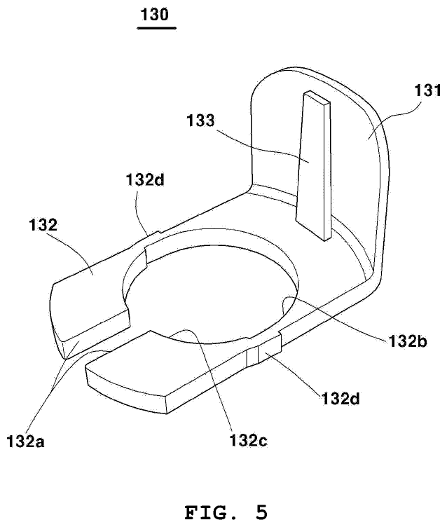

In more detail, as shown in FIG. 5, the detachable member 130 includes: a pressing part 131 guided to the guide part 121; a slide part 132 extended perpendicularly from the underside of the pressing part 131 and having cut portions 132a guided to the operating hole 122, a first inner diameter portion 132b formed extendedly from the cut portions 132a to guide the outer periphery of the mounting part 201 of the filter cartridge 200, a second inner diameter portion 132c for lockedly supporting the groove 202 of the mounting part 201 of the filter cartridge 200, and escape prevention projections 132d formed on both side surfaces thereof in such a manner as to be guided to the operating grooves 123, while being prevented from the escape from the operating grooves 123; and an elastic piece 133 protruding vertically from the top of the slide part 132 in such a manner as to allow one side thereof to come into contact with the slant projections 124 of the lower body 120 upon the forward movement of the detachable member 130 to provide elasticity in forward and backward directions of the detachable member 130.

The elastic piece 133 has given width and thickness so that the top end portion thereof may be gently bent or easily returned to its original shape when comes into close contact with the slant projections 124, and desirably, the thickness of the elastic piece 133 becomes small toward the upper portion thereof.

A reference numeral 203, which is not explained yet, denotes a water inlet hole, and a reference numeral 204 denotes a water drain hole for inserting the filter cartridge insertion pipe 113 thereinto.

In the drawings, a reference numeral of an O-ring mounted on each part so as to prevent water leakage will be not indicated.

Under the above-mentioned configuration, now, an explanation on an operation of the filter cartridge connecting structure according to the present invention will be given.

The connectors 100 generally disposed in a body (not shown in the drawings) of the water purifier are fixedly extended from one another by means of the connection sockets 1 according to the number of filter cartridges 200 provided in one way.

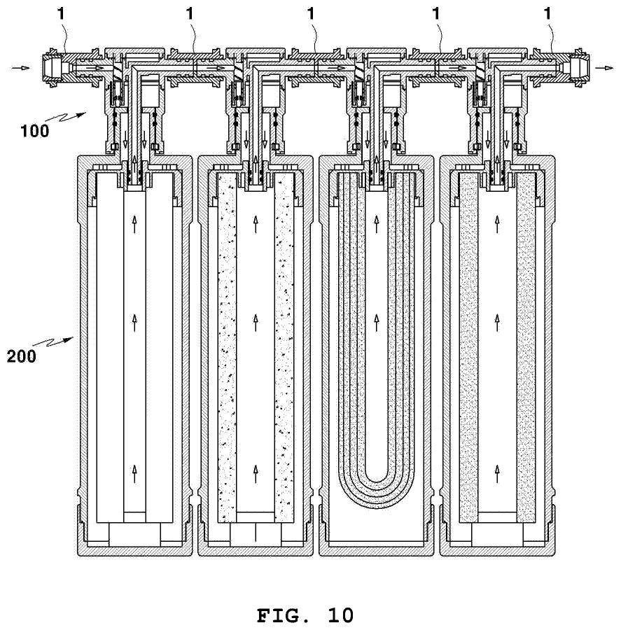

The filter cartridges 200 are mounted in the order of the sediment filter, the pre carbon filter, the hollow fiber filter, and the post carbon filter from the left side of FIG. 10 at which raw water is fed from tap water, and if the filter cartridges 200 have to be exchanged, they are just detached and then exchanged with new ones.

Each filter cartridge 200 is exchanged with new one in the state where the pressing part 131 of the detachable member 130 disposed on the guide part 121 of the lower body 120 of the connector 100 is pressed.

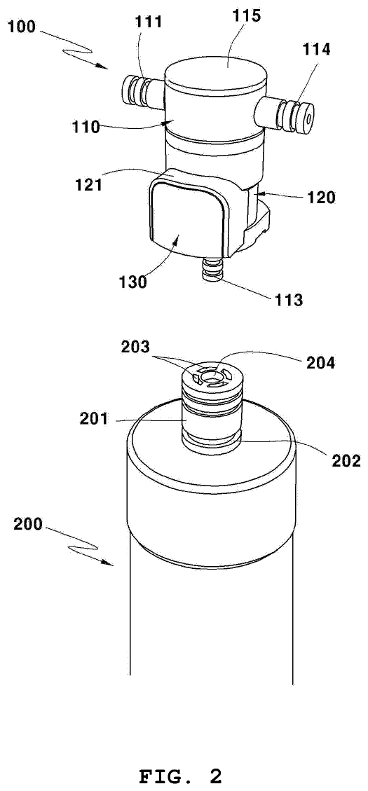

So as to mount the filter cartridge 200 onto the connector 100, as shown in FIG. 2, the mounting part 201 of the filter cartridge 200 is located vertically under the connector 100, and next, the filter cartridge insertion pipe 113 protruding downward from the upper body 110 after penetrated into the lower body 120 is inserted into the water drain hole 204 of the mounting part 201.

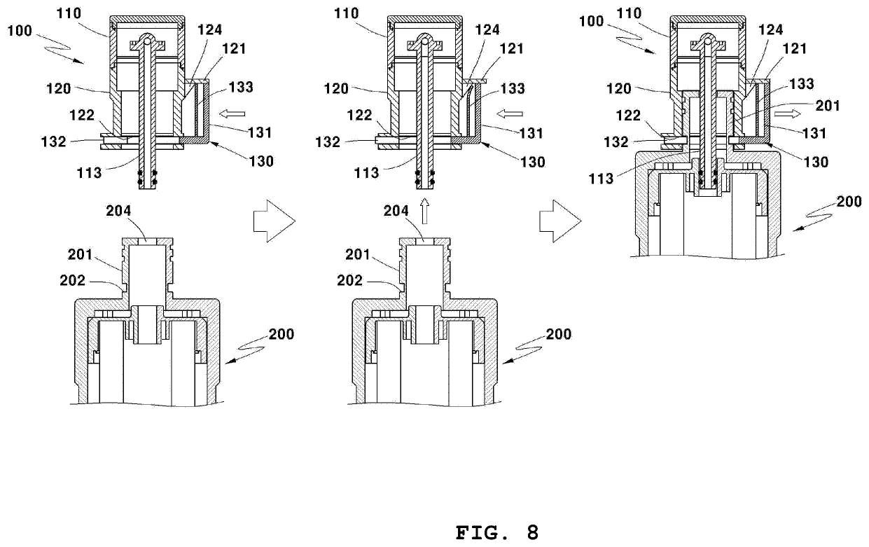

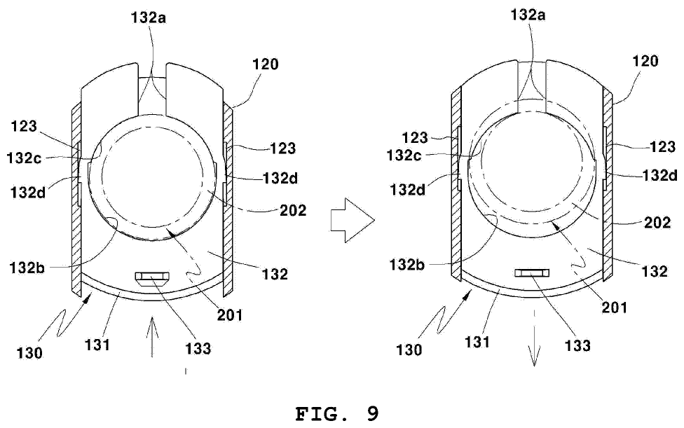

At this time, if the pressing part 131 of the detachable member 130 is pressurized, as shown in FIG. 8, the slide part 132 of the detachable member 130 moves backward through the operating hole 122 of the lower body 120, and accordingly, the outer periphery of the mounting part 201 of the filter cartridge 200 is inserted into the first inner diameter portion 132b and the second inner diameter portion 132c of the slide part 132 (See FIG. 9).

If the mounting part 201 of the filter cartridge 200 is pushed upward, in this state, the filter cartridge insertion pipe 113 is completely inserted into the filter cartridge 200, and at the same time, the groove 202 of the mounting part 201 of the filter cartridge 200 is positioned in parallel with the positions of the first inner diameter portion 132b and the second inner diameter portion 132c. If the pressurized force against the detachable member 130 is removed, at this time, the detachable member 130 is returned to its initial state, and as shown in

FIG. 9, a portion of the second inner diameter portion 132c is fastendedly guided to the groove 202, thereby supportingly mounting the filter cartridge 200 thereon.

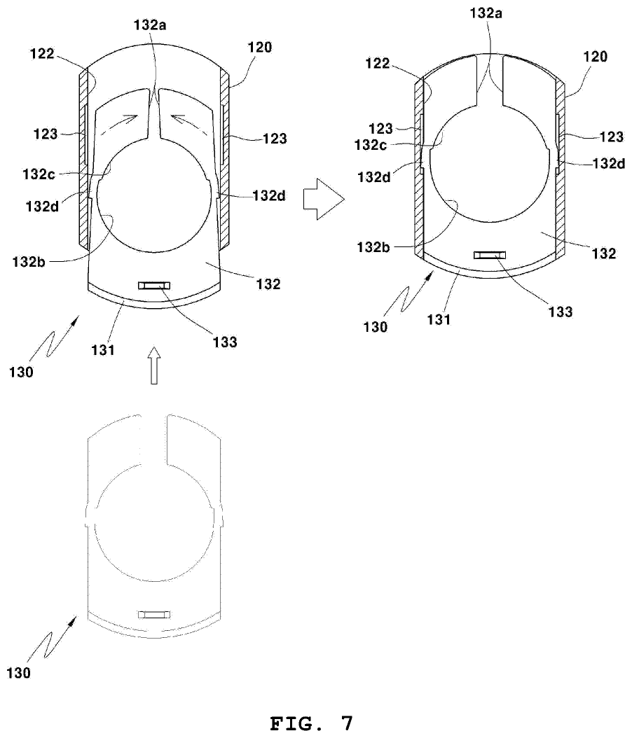

At the time when the detachable member 130 is initially inserted into the operating hole 122 of the lower body 120, as shown in FIG. 7, the cut portions 132a of the slide part 132 become close to each other so that the escape prevention projections 132d formed on both sides of the detachable member 130 are guided correspondingly to the operating grooves 123 formed on both sides of the operating hole 122. Like this, at the time when the detachable member 130 is pressurized or released from the pressed state, the detachable member 130 can horizontally move forward and backward, without any escape from the operating hole 122.

In the state where the pressing part 131 of the detachable member 130 is pressurized by a user's hand, on the other hand, the elastic piece 133 located behind the pressing part 131 comes into close contact with the slant projections 124 formed on the lower body 120, and at the same time, is bent along the slant projections 124 by the forward movement of the detachable member 130 pressurized, thereby providing the given elasticity. If the pressing part 131 is released from the user's pressurizing force, at this time, the detachable member 130 is returned to its initial state by means of the repulsive force of the elastic piece 133.

Only through the operations for pressurizing the detachable member 130, pushing the mounting part 201 of the filter cartridge 200 upward, and releasing the user's pressurizing force, the filter cartridge 200 can be easily detachably mounted on the connector 100.

If the operation for mounting the filter cartridge 200 is finished, the check valve 10 guidedly disposed in the water inlet pipe 112 branched from the water inlet port 111 of the upper body 110 comes into close contact with the top end periphery of the filter cartridge 200 on the underside end periphery thereof, and at the same time, the check valve 10 pressurizes the spring S disposed in the water inlet pipe 112 in such a manner as to be retreated upward, so that a path through which the water passes becomes open. From this time, the water passing around the check valve 10 is introduced into the water inlet holes 203 of the mounting part 201 of the filter cartridge 200 and is then purified through a filter within the filter cartridge 200. At the time when the filter cartridge 200 is exchanged with new one, on the other hand, the spring S pressurizes the check valve 10 downward to allow the path to become closed, thereby blocking the introduction of the raw water.

As mentioned above, the water passing through the filter built in the filter cartridge 200 is discharged through the water outlet port 114 of the upper body 110 from the filter cartridge insertion pipe 113 and is then passed through the filter cartridge 200 mounted onto the adjacent connector 100.

As the detachable member movable forward and backward on the lower body is simply pressurized or released from the pressurizing force, the filter cartridge can be detachably mounted onto the connector, the detachable member can be easily coupled to the connector having the lower body fastened to the upper body, and after the use, the filter cartridge can be conveniently exchanged with new one by means of one touch.

As described above, the filter cartridge connecting structure for the water purifier according to the present invention is simply configured to stably mount the filter cartridge onto the connector and to fixedly dispose the connector in the water purifier, without any rotation, thereby advantageously preventing water leakage occurring on a connection portion due to the rotation of the connector in the existing conventional practice.

In addition, the filter cartridge connecting structure for the water purifier according to the present invention is configured to have the detachable member pressurized through the elastic piece, without any separate spring, thereby reducing the whole manufacturing cost of the connector and providing a mold with a simple design, without any complication.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

It is therefore intended that the scope of the invention be limited not by this detailed description, but rather by the claims appended hereto.

What is claimed is:

1. A filter cartridge connecting structure for a water purifier, comprising:
a plurality of connectors (100) connected in series to one another by means of connection sockets (1); and
a plurality of filter cartridges (200) detachably mounted onto the connectors (100) and thus exchanged with new ones, each filter cartridge (200) having a mounting part (201) and a groove (202) formed on the mounting part (201),
wherein each connector (100) comprises:
an upper body (110) having a water inlet port (111) for introducing water into the corresponding filter cartridge (200), a water inlet pipe (112) for inducing the water passing through the water inlet port (111) to the interior of the filter cartridge (200), a filter cartridge insertion pipe (113) inserted into the filter cartridge (200), a water outlet port (114) for discharging the water passing through the filter cartridge insertion pipe (113), and a finishing cap (115) coupled coveredly to top thereof;
a lower body (120) having a cylindrical body whose top periphery is attachedly coupled to the underside periphery of the upper body (110) in such a manner as to accommodate the water inlet pipe (112) of the upper body (110) therein and to pass the filter cartridge insertion pipe (113) therethrough, the lower body (120) comprising a tunnel-shaped guide part (121) protruding from one side thereof, an operating hole (122) formed transversely on the lower portion of the inner side of the guide part (121), operating grooves (123) formed on both sides of the operating hole (122), and slant projections (124) formed above the operating hole (122) in such a manner as to be protrudingly connected to the upper portion of the inner side of the guide part (121); and
a detachable member (130) having a front surface guided to the guide part (121) of the lower body (120) and one side movable forward and backward on the operating hole (122) in such a manner as to supportedly lock the groove (202) of the mounting part (201) of the filter cartridge (200) guided under the lower body (120) thereonto.

2. The filter cartridge connecting structure according to claim 1, wherein the detachable member (130) comprises:
a pressing part (131) guided to the guide part (121);
a slide part (132) extended perpendicularly from the underside of the pressing part (131) and having cut portions (132a) guided to the operating hole (122), a first inner diameter portion (132b) formed extendedly from the cut portions (132a) to guide the outer periphery of the mounting part (201) of the filter cartridge (200), a second inner diameter portion (132c) for lockedly supporting the groove (202) of the mounting part (201) of the filter cartridge (200), and escape prevention projections (132d) formed on both side surfaces thereof in such a manner as to be guided to the operating grooves (123), while being prevented from the escape from the operating grooves (123); and
an elastic piece (133) protruding vertically from the top of the slide part (132) in such a manner as to allow one side thereof to come into contact with the slant projections (124) of the lower body (120) upon the forward movement of the detachable member (130) to provide elasticity in forward and backward directions of the detachable member (130).

3. The filter cartridge connecting structure according to claim 2, wherein a thickness of the elastic piece (133) becomes small toward the upper portion thereof.

4. The filter cartridge connecting structure according to claim 1, wherein the water inlet pipe (112) is configured to allow a check valve (10) and a spring (S) to be guidedly disposed therein.
